(19) United States
(12) Patent Application Publication
(10) Pub. No.: US 2015/0305388 A1
(43) Pub. Date: Oct. 29, 2015

(54) PROCESS FOR SEPARATING TALLOW AND LEAN BEEF FROM A SINGLE BONELESS BEEF SUPPLY

(71) Applicant: Anthony J.M. GARWOOD, Mercer Island, WA (US)

(72) Inventor: Anthony J.M. GARWOOD, Mercer Island, WA (US)

(73) Assignee: SAFEFRESH TECHNOLOGIES, LLC, Mercer Island, WA (US)

(21) Appl. No.: 14/389,288

(22) PCT Filed: Mar. 29, 2012
(86) PCT No.: PCT/US2012/048017

§ 371 Date: Jul. 8, 2015

Related U.S. Application Data
(60) Provisional application No. 61/617,511, filed on Mar. 29, 2012.

(51) Int. Cl. A23L 1/31; A23L 1/317; A23L 1/015; A23B 4/015

(52) U.S. Cl. CPC A23L 1/31; A23B 4/015; A23L 1/317; A23L 1/015; A23V 2002/00

(57) ABSTRACT

A method for the separation of fat from beef. The method includes reducing the size of beef into particles, wherein the particles are either predominantly fat particles or predominantly lean particles; combining the fat and lean particles with a fluid, wherein a density of the fluid is greater than fat particles, and a temperature of the fluid is greater than a temperature of the lean particles, and the fluid density is adjusted to provide a predetermined proportion of lean particles to sink in the fluid; allowing the fat and lean particles to rise or fall in the fluid, while the temperature of the lean particles equilibrates with the temperature of the fluid, and increases the density of the lean particles; separating the fat particles from the lean particles to produce a lean beef product.

### BACKGROUND

During the process of boning a carcass, and particularly a beef carcass such as a steer or cow, the tallow and fat often referred to as “trim,” is removed. Other “trim” is cut from primal beef portions during the slicing and disassembly process of carcasses that is required during preparation of small cuts for human consumption. During these processes, a significant amount of lean beef can be cut from the carcass and carried away with the fat and/or tallow. Lean beef comprises predominantly muscle protein, although some amounts of fat and tallow are present, while fat and tallow comprise predominantly glycerides of fatty acids with connective tissue and collagen and are the predominant constituents of plant and animal fat. The lean beef content in trim may be as high as 45% to 50% by weight, or higher. Presently, trim has little use except for sausage production, or alternatively the fat may be rendered.

A need therefore exists to more efficiently separate the lower value tallow with fat from the higher value lean beef contained in trim and to more effectively kill, reduce, or completely remove the microbial pathogenic population and to eliminate sources of cross contamination and recontamination, while also producing a ground beef product of specific fat content.

### SUMMARY

Disclosed are methods relating to the reduction in the tallow content and/or the separation of tallow and/or fat from materials, particularly for foods used for human consumption, including fresh, uncooked meats, and in particular beef. Applicant has made numerous contributions to the processing of beef, and in particular to the separation of fat from beef to produce beef products having a desired content of fat, including processes that perform decontamination of the beef with such separation. The following applications are expressly incorporated herein by reference in their entirety: U.S. application Ser. No. 13/024,965, filed on Feb. 10, 2011; Ser. No. 12/968,045, filed on Dec. 14, 2010; Ser. No. 12/520,802, filed on Jan. 12, 2010; Ser. No. 13/024,178, filed on Feb. 9, 2011; Ser. No. 11/720,594, filed on Apr. 30, 2009; Ser. No. 12/697,592, filed on Feb. 1, 2010; Ser. No. 13/422,740, filed on Mar. 16, 2012; Ser. No. 13/355,953, filed on Jan. 23, 2012; Ser. No. 13/324,744, filed on Dec. 13, 2011; and Provisional Application No. 61/595,537, filed on Feb. 6, 2012.

Tallow comprises natural proportions of fat, collagen, and connective tissue. Fat is a single component contained within tallow. Disclosed herein is a method and apparatus for separating lean beef from fat contained within the lean beef component without destruction of the muscle striations or reduction to small lean particulates. The method includes reducing the temperature of at least the fat component of the beef to a temperature causing solidification of the fat and to a brittle condition so that when a crushing action is applied to the temperature-reduced pieces of beef, the crushing force is sufficient to cause fracturing and the substantial disintegration or fragmentation of the fat matter into small fat particles or fragments that readily fall away from the lean beef, but without significantly damaging the lean matter. The temperature-reduced and crushed stream of fat and lean particles can then be transferred to a vibratory separator, which can separate a portion of the fat particles while agitating and shaking the larger lean pieces so as to cause even more fat particles to separate from the larger lean beef pieces. Then, the separated fat particles and larger lean beef pieces can be combined with a fluid that comprises carbon dioxide and/or water, to form carbonic acid. Alternatively, the vibratory sieve can be omitted and the fat particles and lean pieces are combined with a fluid after being crushed. The fat and lean particles with fluid are transferred into to a vessel. The beef and the fluid are agitated in the vessel to allow temperature equilibration above the freezing point of water. The beef particles comprise relative lower amounts of less dense (fat) and higher amounts of more dense (lean) matter, which includes a greater quantity of frozen water. The heavy matter that is predominantly lean beef, when at least water partially unfreezes, increases its density, and can then settle to the bottom of the fluid and the light matter that is predominantly tallow and fat can rise toward the surface of the fluid. The separated matter comprising predominantly lean beef can be removed from the fluid as a reduced tallow and fat content beef product. The method can be practiced with any material containing fat, not just beef, including plants and animals.

Also disclosed is a method for producing a lean beef product. The method includes, reducing the size of beef into particles, wherein the particles are either predominantly fat particles or predominantly lean particles; combining the fat and lean particles with a fluid, wherein a density of the fluid is greater than fat particles, and a temperature of the fluid is greater than a temperature of the lean particles, and the fluid density is adjusted to provide a predetermined proportion of lean particles to sink in the fluid; allowing the fat and lean particles to rise or fall in the fluid, while the temperature of the lean particles equilibrates with the temperature of the fluid, and increases the density of the lean particles; and separating the fat particles from the lean particles to produce a lean beef product. The method may further include emulsifying the fat particles into an emulsification of oily material and solids, pasteurizing the oily material; centrifuging the emulsification to separate solids from the oily material. The method may further include combining the solids with the lean particles. The method may further include combining the lean particles with a measured amount of the fat particles, after the fat particles have been separated from the lean particles. The method may further include providing sufficient fluid to fluidize the particles, wherein the particles are free to rotate or tumble in the fluid, and exposing the fluidized particles to UVc energy to produce a pathogen deactivated beef product. The method may further include treating the lean particles under reduced pressure to adjust water content and lower the temperature of the beef product to produce a controlled water content beef product. The method may further include chilling the beef to a temperature at which the fat will break off from lean beef through application of pressure, and applying pressure to break off fat from lean and produce the particles that are either predominantly fat particles or predominantly lean particles. The method may use a fluid wherein the density is greater than 55.0 lbs/cubic foot and less than 66.0 lbs/cubic foot.

The fluid can include water, or water with an acid, such as carbon dioxide, or water with an alkaline compound. When pressurized, the fluid can have a pH of about 3 or higher, or even lower, such that when the beef is blended in the fluid for a period of time, any bacteria that is present at the beef surfaces is either killed or injured. Furthermore, the processing of the beef in a substantially all carbon dioxide environment around the beef extends the shelf life of the beef by at least displacing oxygen from contacting the beef surfaces.

A method is disclosed that includes preparing diced beef pieces having been completely frozen to a temperature, for example, below 27 F and most preferably to about 15 F or lower, such that the consistency of the frozen beef pieces is hard but is not frozen to a temperature so low that the pieces resist crushing. The treatment comprises the application of a crushing force most preferably from opposing sides of the frozen beef and in a way that traps the beef pieces between, for example, a pair of horizontally opposed, counter- or co-rotating, rigid rollers that apply a crushing force to the beef pieces, and with the rollers rotating such that when the frozen beef is dropped into the space between the rollers, the space is about half the size of the diced beef pieces and the rollers rotate so as to carry the frozen beef in a downward direction. This treatment is arranged to reduce the size of the frozen diced beef to particles wherein the frozen fat has fractured and crumbled into smaller crumb like particles and separated from the larger pieces of lean beef. The diced beef is compressed such that the fat fractures and breaks into smaller particles that are generally smaller than the lean component, which, due to its fibrous properties, resists fracturing and tends to remain unaffected by the crushing force. Following crushing, the stream of beef particles comprises pieces of fat that are substantially fatty adipose tissue with no or very little visible lean attached, while the lean particles are mostly larger than the fat particles and comprise mostly lean after the fat has fractured into crumbs and fallen away from the lean. The stream is then combined. with fluid that comprises filtered, clean water, or carbon dioxide and water, carbonic acid (or liquid carbon dioxide), or any suitable organic acid such as ascorbic acid, acetic acid, per-acetic acid, acidified sodium chlorite. Additionally, or alternatively, the fluid may comprise an alkaline agent. The fluid can be clean, potable water or other fluids or a combination of fluids with agents. Fluids may include water, or fluid carbon dioxide, or both. The fluid may further include acids, either organic or inorganic, and alkaline agents. Acids include, but are not limited to carbonic acid (water and carbon dioxide), lactic acid, ascorbic acid, acetic acid, citric acid, peracetic acid also known as acid (CH₃CO₃H). Alkalinity of the fluid may be raised by adding an alkali substance, such as ammonia, ammonium hydroxide, sodium hydroxide, potassium hydroxide, calcium hydroxide, tri-sodium phosphate, and any other suitable alkali. Additives such as sodium chloride, sodium chlorite, and sodium hydroxide may be added which can be followed by addition of a suitable acid (to provide acidified sodium chlorite).

The beef and fluid are transferred into a vessel. The beef particles comprise relatively light fat and heavy lean and even heavier bone fragment components, however until the temperature of the frozen water containing lean beef particles has equilibrated (with the fluid) at a temperature above the freezing point of the water containing lean beef particles, when frozen the lean beef will float, suspended in the fluid, but will sink after the temperature of the lean particles has equilibrated at above its freezing point. This provides a window of opportunity to collect any bone fragments, unaffected by freezing, that will sink before the lean beef particles and can therefore be isolated in the lowest separation vessel compartment by closing a gate valve between the lowest vessel compartment and the upper enclosures and apparatus. The components that are predominantly lean beef will, after equilibrating at a temperature above the freezing point of lean beef, settle to the bottom of the fluid, and components that are predominantly fat will rise to the surface of the fluid. The separated components comprising predominantly lean beef can be removed from the fluid as a reduced fat content beef product. The method can be practiced with any material containing fat, including plants and animals.

### DESCRIPTION OF THE DRAWINGS

The foregoing aspects and attendant advantages will become more readily appreciated as the same become better understood by reference to the following detailed description, when taken in conjunction with the accompanying drawings, wherein:

FIG. 1 is a schematic illustration of a process for the separation of lean beef from boneless beef containing lean beef and tallow;

FIG. 2 is a schematic illustration of a process for the separation of lean beef from boneless beef containing lean beef and tallow;

FIG. 3A is a schematic illustration of a process for the separation of lean beef from boneless beef containing lean beef and tallow;

FIG. 3B is a schematic illustration of a process for the separation of lean beef from boneless beef containing lean beef and tallow;

FIG. 4 is a schematic illustration of a process for the separation of lean beef from boneless beef containing lean beef and tallow;

FIG. 5 is a schematic illustration of a process for the separation of lean beef from boneless beef containing lean beef and tallow;

FIG. 6 is a schematic illustration of a process for the separation of lean beef from boneless beef containing lean beef and tallow; and

FIG. 7 is a schematic illustration of a process for the separation of lean beef from boneless beef containing lean beef and tallow.

### DETAILED DESCRIPTION

The term “fat” as used herein can mean fat and tallow when used in reference to animal matter. Throughout the description “beef” may be used as a representative material that can be used in the disclosed methods. However, it is to be appreciated that the disclosed methods can be practiced not only on beef, but on any meat, such as from poultry, pork, seafood, and the like.

The disclosed method is a process for the processing of beef and, specifically, a process for separating lean beef and fat from boneless beef and producing a product of specified fat content, and treating the product to deactivate and/or destroy pathogens. However, the beef need not be boneless. In one embodiment, beef with bone fragments may also be processed in accordance with the disclosure.

From the description herein, a method for producing a lean beef product is disclosed. The method includes: reducing the size of beef into particles, wherein the particles are either predominantly fat particles or predominantly lean particles; combining the fat and lean particles with a fluid, wherein a density of the fluid is greater than fat particles, and a temperature of the fluid is greater than a temperature of the lean particles, and the fluid density is adjusted to provide a predetermined proportion of lean particles to sink in the fluid; allowing the fat and lean particles to rise or fall in the fluid, while the temperature of the lean particles equilibrates with the temperature of the fluid, and increases the density of the lean particles; and separating the fat particles from the lean particles to produce a lean beef product. The method may further include: emulsifying the fat particles into an emulsification of oily material and solids; pasteurizing the oily material; centrifuging the emulsification to separate solids from the oily material. The method may further include combining the solids with the lean particles. The method may further include combining the lean particles with a measured amount of the fat particles, after the fat particles have been separated from the lean particles. The method may further include providing sufficient fluid to fluidize the particles, wherein the particles are free to rotate or tumble in the fluid, and exposing the fluidized particles to UVc energy to produce a pathogen deactivated beef product. The method may further include treating the lean particles under reduced pressure to adjust water content and lower the temperature of the beef product to produce a controlled water content beef product. The method may further include chilling the beef to a temperature at which the fat will break off from lean beef through application of pressure, and applying pressure to break off fat from lean and produce the particles that are either predominantly fat particles or predominantly lean particles. The method may use a fluid wherein the density is greater than 55.0 lbs/cubic foot and less than 66.0 lbs/cubic foot.

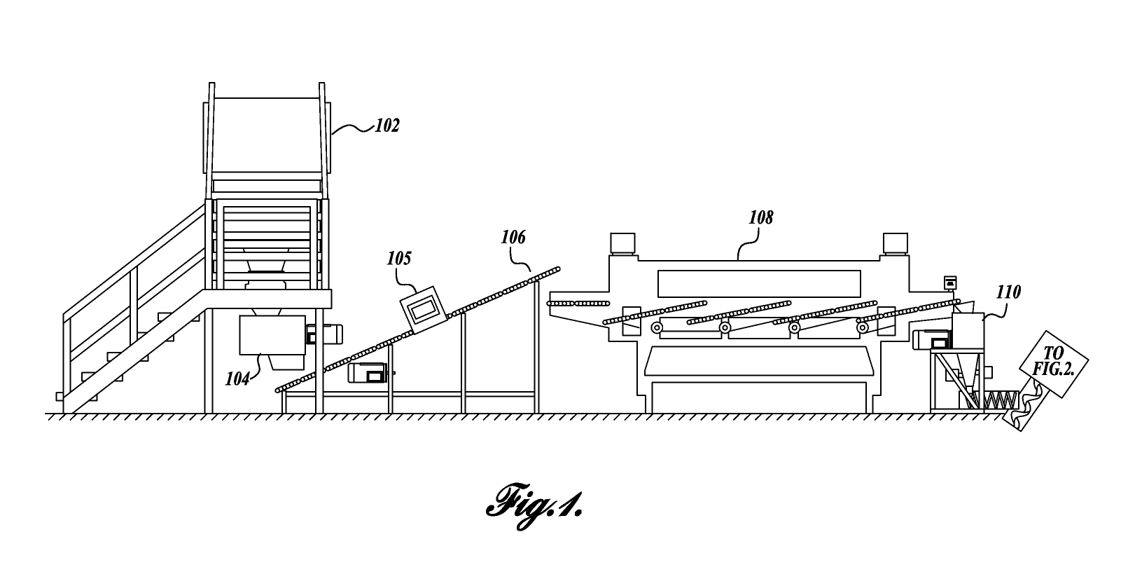

FIG. 1 illustrates the first steps in the process of separating the lean beef from animal matter that is a combination of fat and lean matter. A representative animal matter may be high fat trim byproduct from beef slaughterhouses. Generally, the animal matter is any boneless beef. In one embodiment, the source materials can comprise a combination of what is commonly known as 50's and 65's boneless beef, or any other suitable boneless beef. However, in other embodiments, the beef may combine bone and cartilage. All materials coming in contact with the boneless beef or any parts thereof, such as lean beef and fat are made from food grade materials, such as stainless steel and suitable polymers, such as nylon, polyethylene, polypropylene, and the like. Furthermore processing equipment may be housed in an enclosed building within a cooled environment and, kept at a temperature near the freezing point of water. Also, instrumentation, such as temperature, level, pressure, flow, density, and mass meters, is provided where necessary to provide status of and/or maintain control of the product through the many components of the system.

The boneless beef, which may include sizable chunks, is loaded onto hopper 102. Hopper 102 represents a vat dumper that may unload any quantity of animal matter containing fat and lean, such as for example, the unloading of containers of approximately 2,000 lb of beef followed by size reduction equipment, such as slicing device 104. From hopper 102, the beef is fed by gravity to a slicer 104. The slicing device 104 is designed to slice and dice the beef and reduce beef to a size, for example, of about 1 inch in cross section by 2 inches or less. While not limiting, the small pieces are size reduced to approximately not more than about 1 inch wide and 2 inches long strips or 2 inch cubes. The individual beef pieces of diced beef may still contain an amount of fat and an amount of lean. Slicing device 104 provides a steady flow of beef pieces to inclined conveyor 106.

The sliced and diced beef pieces continue along the inclined conveyor 106, and are delivered to the entry of a chilling tunnel 108. The chilling tunnel 108 is for chilling the beef to a temperature at which the fat will break off from lean beef through application of pressure that breaks off fat from lean and produces particles that are either predominantly fat particles or predominantly lean particles. Processing of the diced beef pieces through the chilling tunnel 108 results in differences in temperature between the fat and the lean matter in each of the individual beef particles, such that the fat is at a temperature that can be separated from the lean by the application of pressure, similar to a crushing force that can break free of the lean matter, and the lean is at a temperature that is pliable and does not result in the lean matter breaking free through the same application of pressure. However, the lean matter is chilled to a temperature at which water within the lean matter can freeze and expand, thus, reducing the density of such lean matter. For example, in one embodiment, the temperature of the beef pieces should be not more than, for example, 29° F. and not less than 0° F., or for example, about 15° F. to about 24° F.

The input temperature of the beef particles to the tunnel 108 may be about 32° F. to 40° F., but preferably about 32° F. The temperature of the beef before the tunnel freezer 108 may be controlled, in general, by adjusting the temperature of the room in which the beef is being diced. Owing to the differences of heat transfer between fat and lean in each beef piece, and respective amounts of water in lean versus fat matter, the chilling tunnel 108 results in different temperatures of fat and lean within each beef piece.

It has been realized that the temperature of the individual pieces that exit the chilling tunnel 108 is not uniform throughout the particles. Because of the different heat transfer rates of fat and lean as well as the different percentages of water within lean and fat, the temperature of the lean will be higher than the temperature of the fat, even of the same piece. The temperature reduction is carried out to result in lean matter that remains flexible due to the cohesive properties of muscle tissue, while the fat is cooler at the surface and is in a brittle and friable condition due to the lower temperature. However, because the lean contains greater amounts of water than fat, the water is frozen or partially frozen.

In one embodiment, flooding the tunnel 108 enclosure with 100% carbon dioxide gas displacing what would otherwise be air is advantageous. In this way, carbon dioxide gas can be recycled through evaporators. Another purpose in the use of carbon dioxide is to displace air (and therefore atmospheric oxygen), thereby inhibiting the formation of oxymyoglobin from the deoxymyoglobin exposed at the cut lean surfaces of each dice or beef particle when diced or sliced.

The temperature of the quickly frozen beef particles when exiting the tunnel 108 is controlled such that lean matter comprising substantially muscle striations, will freeze the water and all naturally fluids. Water represents about 70% of lean matter, and thus the freezing and expansion of water when frozen contributes a significant increase in volume with a corresponding decrease in density of the lean matter. The beef pieces are in a solid phase but in such a way that the physical characteristics and properties of the lean matter is pliable and “rubbery” in texture, while the fat matter is friable such that it fractures when subjected to compressive and twisting actions and will crumble readily into small particles and be freed from the lean matter. The temperature to which the beef pieces are reduced needs to alter the physical condition of the beef pieces so as to facilitate the flexing of the muscle striations of the lean matter without causing it to fracture and break into smaller pieces, while simultaneously rendering the fat matter friable such that it will fracture, crumble, and break into smaller separate particles. In this way, the friable fat having broken away from the lean when it is flexed, crushed, bent, or twisted, thereby reduces the fat matter into small separated particles. Hence, these are referred to herein as fat particles. The beef pieces remaining after fat is broken off are relatively larger comprising mostly lean matter (because they are generally not broken into small particles). Hence, these are referred to herein as lean particles. The change in physical breakdown of the beef particles into two types of particles is caused by lowering the temperature thereof followed by physical disruption of the bond, which fixes the fat and lean matter together in an attached state and results in a size difference between the larger lean particles compared to smaller fat particles.

It has been found that reducing the temperature of the beef pieces with fat to a range of, for example, between less than 29° F. and above 26° F., will facilitate separation by providing friable fat fractures permitting the fat to crumble into small particles, leaving the lean as larger particles.

The chiller 108 may be a cryogenic freezer using nitrogen or carbon dioxide as the refrigerant, such that upon transfer out of the chiller 108 (or other style of freezer) the temperature of the fat (at its surface) is lower than the temperature of the lean in each particle or separate piece of beef. In one embodiment, the beef particles are temperature reduced by transfer through chiller 108 such that the surface temperature of the fat matter is lower (approximately 5° F.) than the surface temperature of the lean matter, which is shown to be about 29° F., immediately following discharge from the freezer. The temperature at the surface of fat may be at about 5° F. or less and up to 10° F. or more such that it can be friable and crumble upon application of pressure, while the temperature of the lean may be 16° F. to about 34° F., for example, or alternatively below 29° F., which makes the lean flexible and not frozen into a “rock-hard” condition immediately after removal from the freezing process.

At the exit of the chilling tunnel 108, the temperature-reduced beef pieces are crushed between rollers in the bond-breaking device. The bond-breaking device is for reducing the size of beef into particles, wherein the particles are either predominantly fat particles or predominantly lean particles. Bond-breaking device 110 includes one or more pairs of opposed rollers, wherein teeth are disposed along the longitudinal direction of each opposed roller. Each individual teeth can run the length of the roller. The intermeshing teeth are in close, but not touching proximity with the teeth of the opposed rollers. The diced and chilled beef pieces leaving the tunnel chiller 110 are deposited by gravity into the gap between the rollers of the bond-breaking device 110. Processing in the bond-breaking device 110 results in the liberation of the fat from the beef pieces, thereby resulting in fat particles and lean beef particles, that formerly comprised the fat particles. Rollers that contact the beef pieces can be smooth or comprise teeth extending the length of the roller. The gap between opposing teeth can be determined based on the size of the fat particles that come from the outlet of the bond-breaking device 110. If the fat particles are too large, the spacing between the opposed rollers can be decreased to reduce the size of fat particles. If the fat particles are too small and/or lean is combined with the fat, then the spacing of the intermeshing teeth can be increased.

The temperature reduced beef pieces can then be, without storing in containers or otherwise that could allow temperature equilibration of the fat and the lean matter, or on an extended conveyor, be transferred through the bond breaking process during which the beef pieces are “flexed” or bent by distortion and partially crushed as they are transferred between, for example, a pair (two) of parallel rollers manufactured from any suitable stainless steel such SS316 or SS304 grades, but wherein the beef pieces are not completely flattened as would occur if placed on a hard surface and rolled upon with a very heavy roller (steam/road roller for example). This bond breaking compression process is intended to cause breakage of the friable fat matter into smaller pieces of, in the majority of instances, approximately 100% fatty adipose tissue (fat) and smaller than the fat matter was before transfer through the bond breaking process and much more so than the lean matter which remains in most cases intact but without any more than about 10% fat, or less, remaining attached to the majority of lean matter after transfer through the bond breaking process. In other words, the fat in the beef pieces will “crumble”, fracture, and break into small pieces and separate from the lean in a continuous stream of what becomes small (smaller than before transfer through the crushing process) fat particles and lean particles that still comprise some fat, but are approximately more than 90% lean beef.

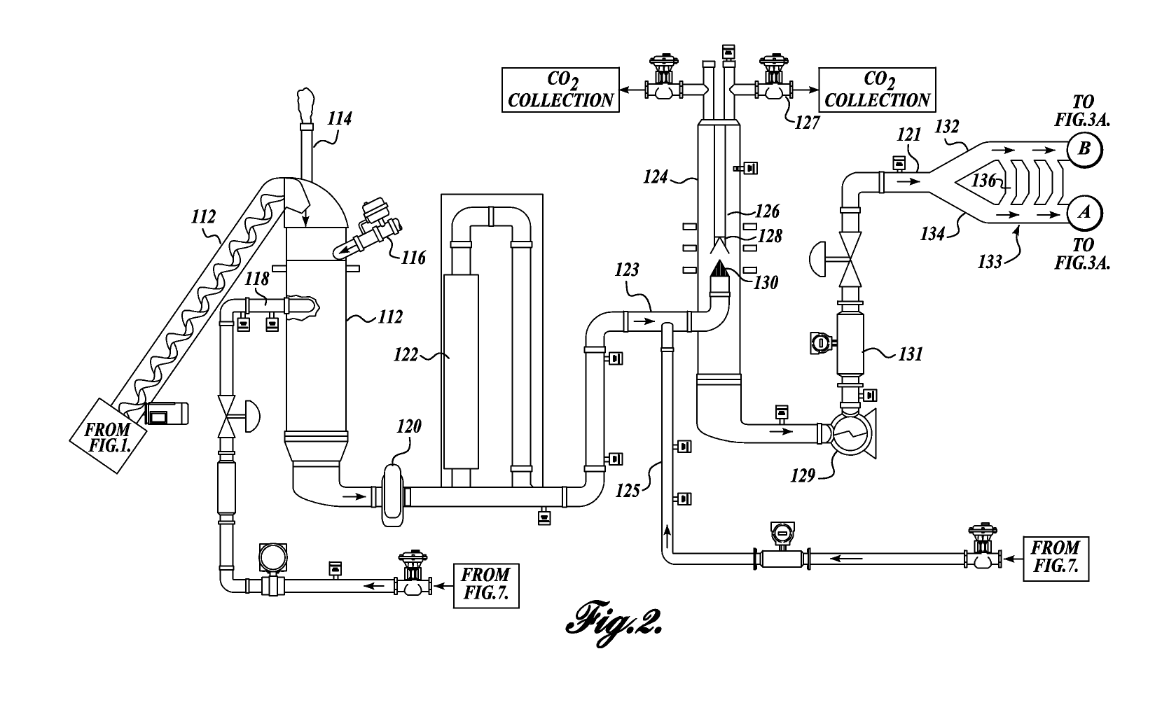

In one embodiment, the fat particles and the lean beef particles exit the bond-breaking device 110 and are deposited to an enclosed screw conveyor 112, which is shown on FIG. 2. In another embodiment, the liberated fat particles and the larger beef pieces may be deposited onto a vibratory sieve with holes large enough for the fat particles to pass through, but not the larger lean beef particles. In the former, a particle separator system 110 may comprise a particle separator that applies pressure to the large particles of beef by way of a horizontally disposed assembly of parallel stainless steel bars. The horizontally disposed assembly of bars can rotate in the lower section of a horizontal trough having a lower profile that follows the underside profile of the rotating bars. The trough material is stainless steel and is perforated with holes of a selected size such that when the rotating assembly of bars is positioned so as to have little clearance between it and the lower section of the perforated trough, any particles of greater size than the perforations will be size reduced by crushing until the reduction in size allows the particles to fall through the perforations.

The size reduced lean beef particles are then returned to enclosed screw conveyor 112, while the fat particles that fall through the sieve or perforated trough are processed in a low temperature rendering section described below. In other embodiments, a sieve can be a rotating sieve, or a sieve having a plurality of different sieve meshes to separate more than two size ranges of particles, for example.

Referring to FIG. 2 again, the inclined screw conveyor 112 deposits the beef particles and the fat particles into the combining tube 112. The combining tube 112 is a vertically situated vessel that is essentially at atmospheric pressure, or slightly above. The combining vessel 112 is for combining fluid with the lean beef particles and the fat particles. The fluid may include water, water with an acid, such as that created by the addition of carbon dioxide, or water with an alkaline compound, or a combination of acids and alkaline agents.

In one embodiment, the temperature of the fluid (suspension or buoyancy medium) should be not less than about 40° F. and not greater than about 60° F., for example, at about 50° F., before being mixed with the lean particles and fat particles.

The combining vessel 112 includes an inlet for the introduction of carbon dioxide gas via a metering valve 116. The combining tube 112 includes an inlet 118 for the introduction of water. The water is deionized and/or purified for use as food-grade water. The amount of water is measured and metered according to the amount of beef supplied to the combining tube 112. Additionally, the pressure and the temperature of the water can also be metered. The fluid is introduced through a conduit 118 placed substantially at a tangent to the exterior of the vessel 112. Thus, this arrangement creates a venturi effect. The energy imparted by the water creates a vigorous mixing action of the beef and fat particles, carbon dioxide, and water. Carbon dioxide in the presence of water produces carbonic acid. Sufficient carbonic acid is introduced into the vessel 112 so as to create a low pH aqueous medium having a pH less than neutral. In one embodiment, the pH can be less than 4. In one embodiment, the pH can be less than 3. In one embodiment, the pH of the aqueous medium in the combining tube 112 is less than 2. The ratio of water to beef and fat particles is on the order of five times the mass of water compared to the mass of fat and beef particles. In some embodiments, the ratio of water to fat and beef particles is on the order of equal mass parts water compared to fat and lean particles. In any event, the amount of water added is sufficient to fluidize the fat and beef particles, such that all surfaces of the fat and beef particles come in contact with the low pH fluid. In cases of insufficient water, the beef and fat particles compact tightly against one another, such that surfaces of the beef and/or fat particles are not exposed to the low pH medium. An advantage of fluidizing particles is to expose all surfaces of the beef and fat particles to low pH aqueous medium (or any other fluid) such that some biocidal effect is realized by such contact.

The temperature of the fluid may be above or slightly above the freezing point of water. As discussed above, the beef particles include water which is slightly frozen such that the density of the beef particles is reduced by expansion of the frozen water within the beef particles. Preferably, the frozen condition of the water within the beef particles is maintained, at least, for a part of the process, for example, until the separation step occurring later in the process.

Additionally and/or alternatively, an alkaline agent, or additional acids may be combined with the fluid in the combining tube 112.

From combining tube 112, the aqueous medium (or any other suitable fluid) containing beef particles and fat particles and, optionally, an acid and/or an alkaline agent is transferred via a variable-speed pump 120. The pump 120 transfers the aqueous medium containing fat and lean particles through a pathogen-deactivation device 122. Sufficient fluid is provided in the pathogen-deactivation device 122 to fluidize the particles, wherein the particles are free to rotate or tumble in the fluid, and expose the fluidized particles to UVc energy to produce a pathogen deactivated beef product. In one embodiment, the pathogen-deactivation device 122 includes an annular passageway for the transfer of the aqueous medium containing the fat and the lean particles. The interior of the annular space is provided with UVc-generating light fixtures. For example, the inner small and large diameter surfaces of the annular space are fitted with UVc-generating light fixtures. As the lean beef and fat particles pass through the annular space, the particles are exposed to UVc energy to deactivate any pathogens on the surfaces of the particles. The particles may be fluidized in the fluid, such that the particles can rotate in all directions as the particles pass within the annular space. Furthermore, the particles being diced creates cleanly cut surfaces, so as to minimize any crevice or crease within which pathogens may avoid direct irradiation of the UVc energy.

From the pathogen-deactivation device 122, the aqueous medium containing the fat and the lean particles are next transferred along a transfer conduit 123 which injects the aqueous medium containing the fat and the lean particles within a mixing tube 124. The mixing tube includes an injector nozzle 130 at the end of the transfer conduit 123. The injector nozzle 130 is directed to face upwards. The mixing tube 124 includes a downward-pointing appendage 126 which terminates in a cone 128. The cone 128 includes a wider opening at a lower elevation and a closed top end. The injector nozzle 130 directs the aqueous medium containing the fat particles and the lean particles directly at the cone 128. The cone 128 induces vigorous mixing. Carbon dioxide gas may be introduced via conduit 125 into the transfer conduit 123 to mix with the aqueous medium containing fat and lean particles. The carbon dioxide gas can be measured and metered to deliver a precise amount.

The mixing tube 124 may include one or more vent conduits for the control of pressure within the mixing tube 124. For example, pressure control valve 127 may release any buildup of pressure within the mixing tube 124 to maintain a consistent pressure within the mixing tube 124.

From mixing tube 124, the aqueous medium containing fat and lean particles and, optionally, carbon dioxide and/or carbonic acid and/or any alkaline or acid agent is transferred via the variable-speed pump 129. The variable speed pump 129 may control the fluid level in the mixing tube 124.

Pump 129 pumps the medium containing fat particles and lean particles to a separator 133. Prior to separator 133, the aqueous medium containing fat and lean particles is measured via Coriolis meter 131. Coriolis meter 131 measures the mass flow of fat and lean particles, as well as the aqueous medium and the respective densities.

In general, separation of the fat particles from the lean (having some fat) particles is done by way of buoyancy separation in a fluid that has a density lower than that of the lean particles, when the water in the lean particles is not frozen. The density of the fluid can be adjusted by adjusting the temperature, or the addition of agents. Separation may also be conducted with a fluid that has a density greater than that of the fat particles. Separation may also be conducted with a fluid that has a density in the range between the fat particles and the lean particles. The fluid can include water, or water with carbon dioxide, which results in the production of carbonic acid. At the temperatures required for bond breaking discussed above, when fluid is first mixed with the lean and fat particles, the particles will float including the lean particles, and be suspended at the uppermost space available in the fluid and just below a surface of the fluid or suspended within the fluid. The temperature of the fluid can be higher than the temperature of the fat and the lean particles. As the temperature of the fluid and fat and lean particles begins to equilibrate, which involves the initial lower temperature of the lean particles increasing, corresponding with the decreasing temperature of the fluid, the buoyancy of the lean particles will start to “fail” until the lean particles sink toward the base of the fluid leaving the fat particles floating at the fluid surface or uppermost available space in the fluid. An increase in the density of the lean particles is seen as the lean and water thaw, which reduces the volume of lean particles and correspondingly increase in density. Fat having a lower content of water does not experience as great an increase in density due to water thawing. As the temperature of the fluid is greater than a temperature of the lean particles, and the fluid density is adjusted to provide a predetermined proportion of lean particles to sink in the fluid, the fat and lean particles are allowed to rise or fall in the fluid in accordance with their density, while the temperature of the lean particles equilibrates with the temperature of the fluid, and increases the density of the lean particles, which facilitates separating the fat particles from the lean particles to produce a lean beef product.

The method may use a fluid wherein the density is greater than 55.0 lbs/cubic foot and less than 66.0 lbs/cubic foot, for example. However, other ranges of fluid density are suitable, and the density of the fluid may be adjusted up in order to allow a greater amount of fat to be carried into the fat product stream, or the density of the fluid may be adjusted down in order to allow a greater amount of fat to be carried into the lean product stream. Alternatively, the density of the fluid may be adjusted up in order to allow a lesser amount of lean to be carried into the lean product stream, or the density of the fluid may be adjusted down in order to allow a greater amount of lean to be carried into the lean product stream.

Before and during the lean particles and fat particles have reached equilibrium with the fluid, any bone chips that may be present will sink when mixed together with the fluid, thereby providing a convenient means of separating bone chips first, which will most preferably be arranged to occur immediately after blending the lean and fat particles with the fluid and before temperature equilibration of the particles or when the lean particle temperature has increased so as to thaw the lean/water content of the lean matter upon which shrinkage of the lean will occur causing it to sink in the fluid. The fat particles, frozen or not, will remain floating at the fluid surface. By lowering the fluid temperature relative to the temperature of the lean particles, complete thawing and temperature equilibration will be delayed and, accordingly, the lean particles will remain suspended for a longer period and this can assist with UVc pathogen deactivation as described below.

The lean and fat particles suspended in an anti-microbial fluid of carbon dioxide and water (at a suitable ratio of fluid to particles in the range of 1:1 to 5:1, or 10:1 to 1:10 by weight) can be treated by exposure to UVc light, which is lethal to pathogens when the exposure is sufficient. The suspension of frozen lean and fat particles in sufficient anti-microbial carbonic acid fluid (or water) can be transferred at a steady rate of transfer through an enclosed/sealed internally polished (preferably stainless steel) tube within which an elongated, tubular profiled, UVc light source is mounted, in parallel with the enclosing tube. As the temperature of the mixture steadily equilibrates, the outer surface of the lean and fat particles thaw, if pathogens are present, the single celled organisms will be at the surface of the beef particles or suspended in the fluid but, in any event, at locations readily accessible to the direct “line of sight” of the UVc light source given that the particles revolve while suspended in the fluid. UVc is lethal to such pathogens as E. Coli 0157:H7 and Salmonellas and such pathogen contamination can be deactivated by adequate exposure to UVc. The particles suspended in the fluid revolve randomly as the mixture is transferred through the UVc apparatus. Pathogens are quickly deactivated when exposed to the UVc light source.

In one embodiment, a separator 133 includes a single conduit 121 which branches into a first 132 and second 134 conduits with one or more connecting conduits between the first and the second conduit. Separators may take on different designs. In one embodiment, the separator 133 includes an upper branch 132 and a lower branch 134 which divide from the common conduit 121 which delivers the aqueous medium containing the fat and the lean particles to the separator 133. At the branch between the upper conduit 132 and the lower conduit 134, the particles with a lower density will be diverted into the upper conduit 132, while the particles having the higher density will naturally sink in the aqueous medium and enter the lower conduit 134. Generally, the particles higher in density will be those containing the greater amount of lean beef, while the particles lower in density will be those containing all or substantially all fat. The aqueous medium is adjusted by either controlling the temperature and/or the density so as to provide a difference in density between particles. The upper conduit 132 includes a vertically inclined portion greater than 0° but less than 90° from the common conduit 121, which then transitions to a horizontal portion. The lower conduit branch 134 includes a vertically descended portion that creates an angle greater than 0° but less than 90° from the common conduit 121, which then transitions to a horizontal portion. One or more connecting conduits, such as 136, connect the bottom side of the upper branch conduit 132 at the horizontal portion with the upper side of the lower branch conduit 134 at the upper portion. The connecting conduits 136 can have a substantially vertical shape or, alternatively, as illustrated, a connecting conduit can have a “bracket” shape having an inclined portion from the lower side of the horizontal portion of the upper branch conduit 132 followed by a vertically straight portion followed by an inclined portion connecting to the upper side of the horizontal portion of the lower branch conduit 134. The connecting conduits 136 allow further transfer of solid material from the upper branch conduit 132 to the lower branch conduit 134 as material passes through the upper branch conduit. Additionally, any solid material having a low density has the opportunity to be transferred through the connecting conduits 136 from the lower branch conduit 134 to the upper branch conduit 132.

Following the separator 133, aqueous medium containing less dense particles, such as fat particles, enters a second stage separator 140. The upper branch conduit 132 is connected at a tangent to the second stage separation vessel 140 at an upper portion thereof. The lower branch conduit 134 enters the second stage separation vessel 140 at a tangent to the second stage separation vessel 140 at a lower portion thereof. The second stage separation vessel 140 may be described as a dual-cone vessel having a cylinder connecting an upper cone with a lower cone. The small diameters of the upper and lower cone portions face outward, such that the larger diameter sections of the cones face toward the center cylindrical section of the vessel 140. The upper conduit branch 132 enters the vessel 140 at the cylindrical section and close to the upper cone section. The lower branch conduit 134 is pumped by a variable-speed pump 138, and then into the separation vessel 140. The purpose of the variable-speed pump 138 is to control the amount of lean beef particles. As the amount of lean beef particles in the lower branch conduit 134 is restricted by the variable speed control pump 138, the remainder of the lean beef particles are forced to transfer in the upper branch conduit 132. This provides a way of controlling the amount of separated lean beef and fat. From the variable-speed pump 138, the aqueous medium containing mainly lean beef particles enters the second stage separation vessel 140. The lower branch conduit 134 enters the second stage separation vessel 140 at a tangent to the vessel 140. Furthermore, the lower branch conduit 134 enters the second stage separation vessel 140 at a location in the cylindrical section of the vessel 140 and close to the lower cone section. The second stage separation vessel 140 is filled with aqueous medium, thus allowing a second separation between those particles higher in density through the lower cone section of the vessel 140 and the particles of lesser density through the upper cone section of the vessel 140. The vessel 140 includes a conduit 160 connected to the uppermost part of the upper cone section of the vessel 140. The conduit 160 withdraws aqueous medium containing fat particles. Particles tending to be higher in density contain mainly lean beef, while particles being of lesser density contain mostly fat and are transferred through the upper outlet of the vessel 140 through conduit 160, which includes a pump 166 and a Coriolis meter 168.

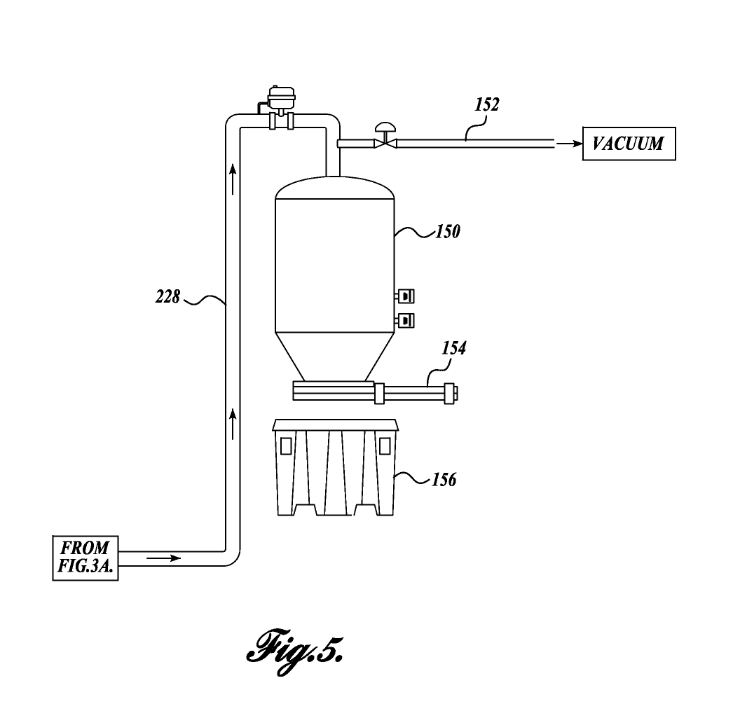

The lower cone section of the vessel 140 collects and withdraws aqueous medium containing the lean particles via conduit 162. Conduit 162 leads to a pump 142 which pumps the aqueous medium containing mainly the lean particles through a mass flow Coriolis meter 164. The aqueous medium containing lean particles is then stored in either of reservoir vessels 144a or 144b. Vessels 144a and 144b rest on load cells which determine when a vessel is filled to capacity. Only one vessel 144a or 144b is generally loaded with material at a time. When the vessel reaches capacity, a transfer valve 172 may automatically switch to load the empty vessel. While one vessel 144a or 144b is being filled, the standby vessel may be emptied of material to be ready to receive material when the other vessel is filled to capacity. The bottom outlets of the vessels 144a and 144b share a common outlet to a pump 146. Pump 146 transfers the aqueous medium and lean beef particles to a vessel illustrated in FIG. 5, which will be described later.

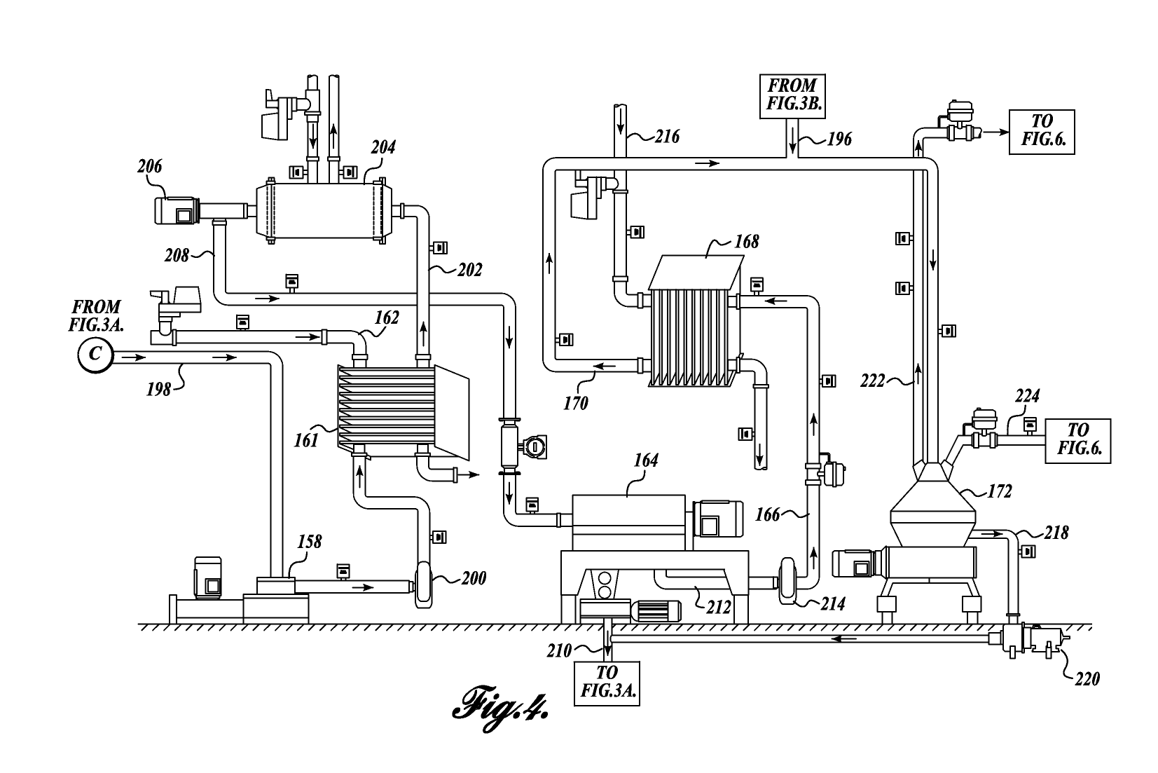

Returning to the second stage separation vessel 140, the aqueous medium and fat particles are withdrawn from the top of the upper cone section of the vessel 140 through conduit 160. Conduit 160 enters pump 166. Pump 166 transfers the aqueous medium containing fat particles via a mass flow meter 168 and then onto fat reservoir vessels 148a and 148b. The fat in vessels 148a and 148b may contain approximately 15% water and 10% to 15% by weight protein. This protein may be recovered in the low temperature rendering section of FIG. 4, and reintroduced to the lean beef in vessels 144a,b.

Vessels 148a and 148b rest on load cells which determine when a vessel is filled to capacity. Only one vessel 148a or 148b is generally loaded with material at a time. When the vessel reaches capacity, a transfer valve 170 may automatically switch to the empty vessel. While one vessel 148a or 148b is being filled, the standby vessel may be emptied of material to be ready to receive material when the other vessel is filled to capacity. The bottom outlets of the vessels 148a and 148b share a common outlet to a pump 174. Pump 174 transfers the aqueous medium and fat particles to a low temperature rendering system illustrated in FIG. 4, further described below. Prior to or after the fat and lean particles are sent to their respective vessels, a process may be conducted to combine the lean particles with a measured amount of the fat particles, after the fat particles have been separated from the lean particles. The fat content of the lean particles, and the fat particles, can be measured via the use of Coriolis meters, and addition of fat can be undertaken to raise the fat content of the lean product stream to a desired level. This can be done by transferring fat from the vessels 148a,b to the lean product stream as it is being transferred into or out of vessels 144a,b. The fat content of the lean product stream may then again be measured to verify the level of fat.

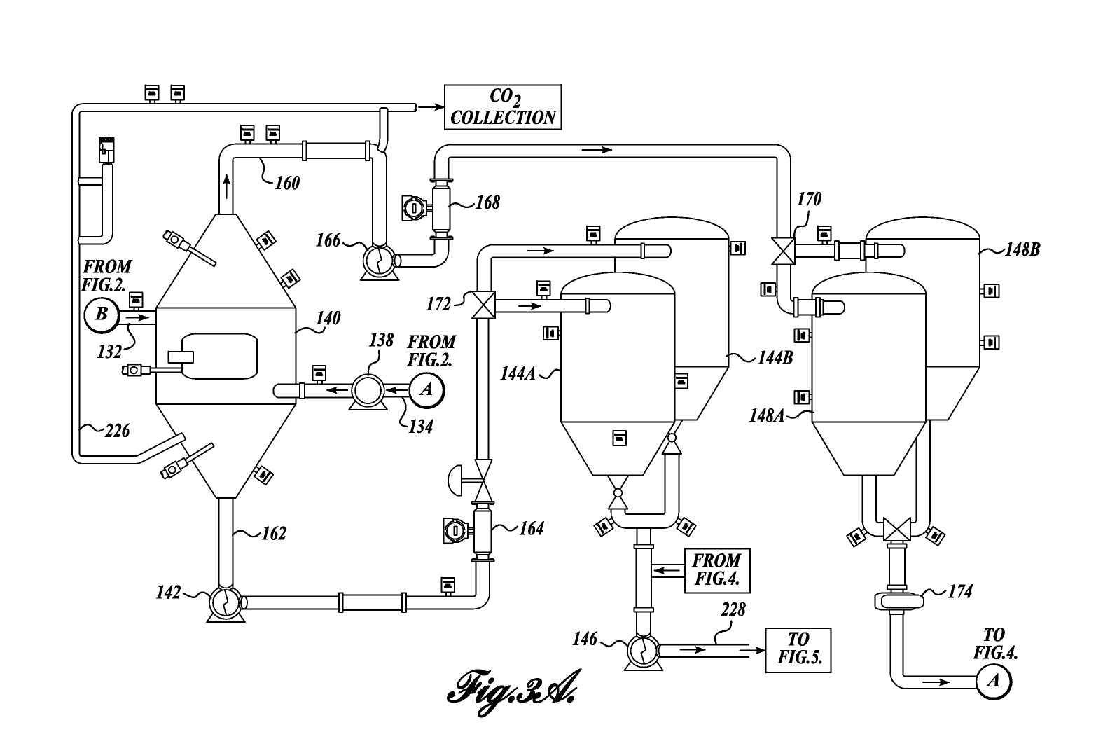

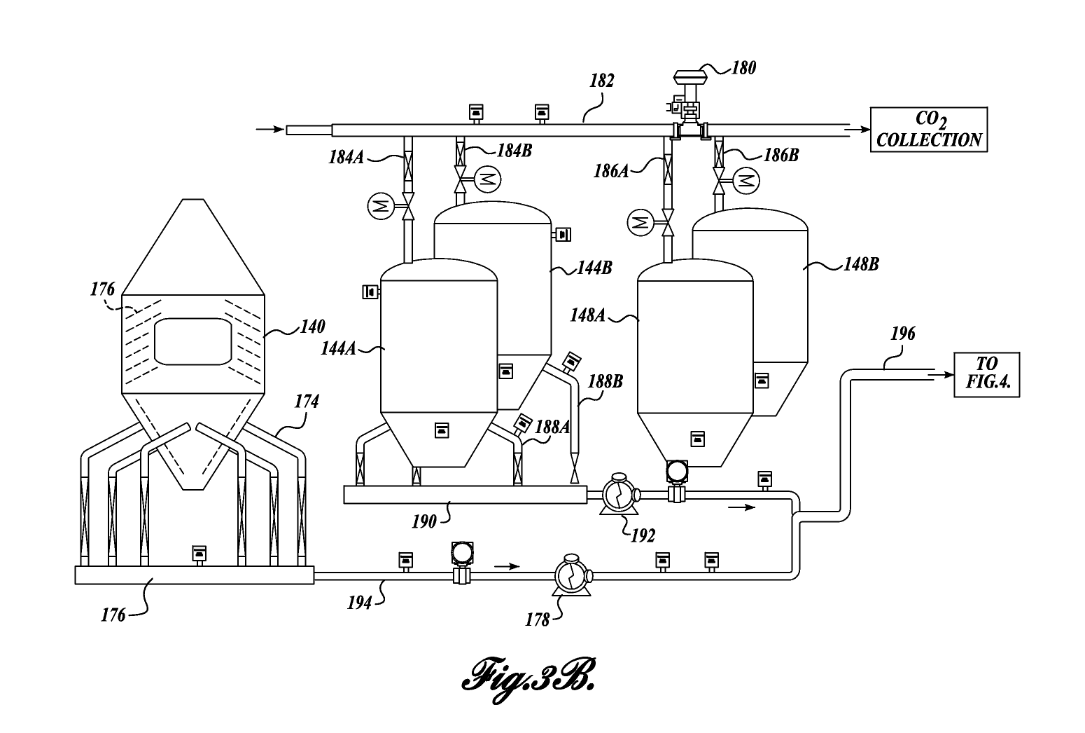

Referring to FIG. 3B, which shows the piping for the aqueous medium, the fluid collection system is illustrated. The second stage separation vessel 140 includes a series of interior plates 176 placed at an angle with respect to the interior wall such that dense particles may easily slide down the plates and then into an annular space surrounding the interior wall, which eventually leads to the bottom of the lower cone section of the vessel 140, and out through conduit 162 described above. A series of fluid collection pipes 174 are placed around the circumference of the lower cone section of the vessel 140. The fluid collection pipes 174 may have filters that prevent particles from being entrained within the fluid collection pipes 174. All fluid collection pipes of vessel 140 lead to a fluid manifold 176. The fluid manifold 176 receives the fluid from the one or more collection pipes 174. The manifold 176 leads to conduit 194.

Fluid in conduit 194 is pumped by pump 178. It should be noted that product storage vessels for lean beef 144a,b may also be of a design that allows the collection of fluid with an interior perforated annular wall. The combined fluid from the separation vessel 140, and the lean beef vessels 144a,b is then transferred to a disk centrifuge 172 for collection of any minute solids.

The lean reservoir collection vessels 144a and 144b similarly include fluid collection pipes 188a and 188b connected to lower cone sections of the vessels 144a and 144b. The fluid collection pipes 188a from vessel 144a and the fluid collection pipes 188b from vessel 144b combine in the manifold 190. Fluid connected in the manifold 190 is pumped via pump 192 and combined with the fluid from the second stage separation vessel 140. The combined fluids are sent via a combined conduit 196 into the disk centrifuge 172 for collection of any solids that may have been carried with the fluid. The lean reservoir vessels 144a and 144b include respective vent pipes 184a and 184b, which connect to the carbon dioxide collection manifold 182. Similarly, fat reservoir vessels 148a and 148b include vent pipes 186a and 186b, respectively, connected to the carbon dioxide manifold 182. The carbon dioxide manifold is maintained at a desired pressure via the system pressure control valve 180.

As described in connection with FIG. 3A above, the fat particles from the fat reservoir vessels 148a and 148b are transferred to a low temperature rendering system. This system is illustrated in FIG. 4. The fat reservoir vessels 148a and 148b are emptied by transferring the fat particles via the conduit 198. The conduit 198 leads into a variable speed emulsifier 158. Emulsifier 158 applies a shear force on the fat particles, generally by the application of a sharp rotating edge. The shear action breaks the walls of any fat cells to produce an emulsification of oily material and solids. The fat material is reduced to an emulsion which is then transferred via pump 200 to one side of a plate heat exchanger 161. Recirculating water is metered and temperature controlled to the plate heat exchanger 161 via conduit 162. The heated fat emulsification leaving the plate heat exchanger 161 through conduit 202 is approximately 108° F. to 180° F. The oily material may be pasteurized by the plate heat exchanger 161.

The fat emulsification transferred through conduit 202 enters a Votator scraped surface heat exchanger 204. In scraped surface heat exchange 204, the fat emulsification is further heated to approximately 160 to 190° F. The fat emulsification from scraped surface heat exchanger 204 is then transferred via conduit 208 to a decanter centrifuge 164. Decanter centrifuge 164 separates solids from the fat emulsification. The solids leaving the decanter centrifuge 164 via outlet 210 may be combined with the lean particles in the lean reservoir vessels 148a and 148b. The decanter centrifuge 164 separates the fat emulsification via outlet 212. The fat emulsification removed via conduit 212 is pumped via pump 214 into conduit 166. Conduit 166 transfers the fat emulsification into a second plate heat exchanger 168. The second plate heat exchanger 168 heats the fat emulsification to approximately 160 to 190° F., and in any event the temperature is raised to pasteurize the fat emulsification. Hot water is provided to the second plate heat exchanger 168 via the hot water recirculation system via conduit 216. The water is returned from the plate heat exchanger 168 to the hot water recirculation system. The fat emulsification leaves the second plate heat exchanger 168 via conduit 170. Conduit 170 transfers the heated fat emulsification into the disk centrifuge 172.

The disk centrifuge 172 separates solids via outlet 218. Solids separated by the disk centrifuge 172 and transferred via conduit 218 are pumped via pump 220 and combined with the solids from the decanter centrifuge 164. The combined solids may be reintroduced into the reservoir vessels 144a and 144b containing the lean particles. Water is separated from the disk centrifuge 172 via conduit 224.

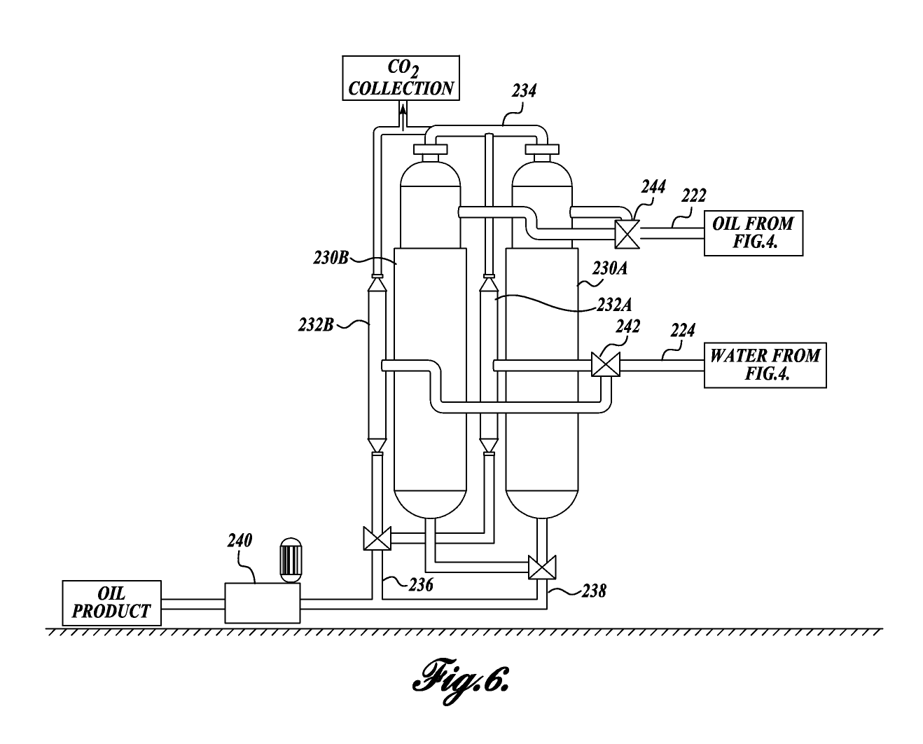

The emulsifier 158 is used to break cell walls of fat to release oil. The solids including the cell walls are transferred with the solids, and will separate in the decanter centrifuge 164 and/or the disk centrifuge 172. The oil is separated from the disk centrifuge via conduit 222 and sent to oil storage vessels 230a,b of FIG. 6. The oil thus produced has many uses. Being food grade, the oil may be used in the manufacture of any type of food, such as snacks, used as commercial cooking oil, as a flavor additive, or any other application of a food-grade oil. Additionally or alternatively, the oil may be used in the production of biodiesel.

Referring to FIG. 5, the finishing step for lean beef product is illustrated. As discussed above, lean beef is stored in lean reservoir vessels 144a and 144b (FIG. 3A). The outlet from the lean reservoir vessels 144a and 144b is pumped via pump 146 through conduit 228. Conduit 228 leads to the top of vessel 150. Vessel 150 is operated under vacuum. The lean beef drops into the vessel 150. Vessel 150 may sit on load cells, which are capable of determining when the vessel 150 is filled to capacity. The vessel 150 is provided with a knife valve 154 at a bottom end thereof. When filled to capacity, the vessel 150 may be emptied onto totes 156 and carried away on trucks or by rail to predetermined destinations. The vessel 150 is connected to a conduit 152 that operates under vacuum. Any remaining carbon dioxide and/or water that may flash vaporize is carried away via vacuum conduit 152. Treating the lean particles under reduced pressure, such as vacuum, adjusts water content and lowers the temperature of the beef product to produce a controlled water content beef product.

The final lean beef product may contain 8% to 10% by weight fat. However, the fat content may be continuously measured and adjusted as necessary, for example, the density of the separating fluid may be varied so as to change the separation point between fat particles and lean particles. Additionally, or alternatively, a variable speed pump may be used to force more fat material to enter the upper branch conduit 132 of the first separator 133, thus changing the ratio of fat to lean that is separated. Additionally, or alternatively, a controlled and measured quantity of fat particles that are collected in the vessels 148a,b may be combined with the lean beef product of vessels 144a,b.

Referring to FIG. 6, the oil separated from disk centrifuge 172 in FIG. 4 is transferred via conduit 222. As seen in FIG. 6, the conduit 222 leads to one of two vessels 230a and 230b. The oil from conduit 222 may enter either one of two oil storage vessels 230a or 230b. Storage vessels 230a and 230b may sit on load cells. Load cells can be used to determine when the vessels 230a and 230b are filled to capacity. The water separated from the disk centrifuge 172 (FIG. 4) is transferred via conduit 224. Conduit 224 leads to one of two vessels 232a and 232b. Vessels 232a and 232b may sit on load cells that are used to determine when the vessels 232a and 232b are filled to capacity. When the load cells detect that the vessels are at capacity, a valve 242 may switch automatically to stop filling the vessel that is at capacity and start filling the empty vessel.

Oil storage vessels 230a and 232b may each have a capacity of approximately 200 gallons, while water storage vessels 232a and 232b may have a capacity of about 15 gallons each. The tops of the vessels 232a, 232b, 230a, and 230b may all be connected at the top end thereof to a common manifold 234. Manifold 234 may lead to carbon dioxide collection.

Vessels 230a and 230b each have an outlet at the bottom end thereof that is combined into a conduit 238. Vessels 232a and 230b have a common outlet 236.

The oil being separated by the disk centrifuge 174 may have little to no water. Accordingly, water that has been initially separated from the fat cells in the emulsification and rendering section may be returned at a rate to achieve an approximately 15% by weight water content in oil. If water is added to the oil, the combination may be treated by a homogenizer 240 to introduce the water back into the oil. The homogenized oil/water may be used as an ingredient in many products.

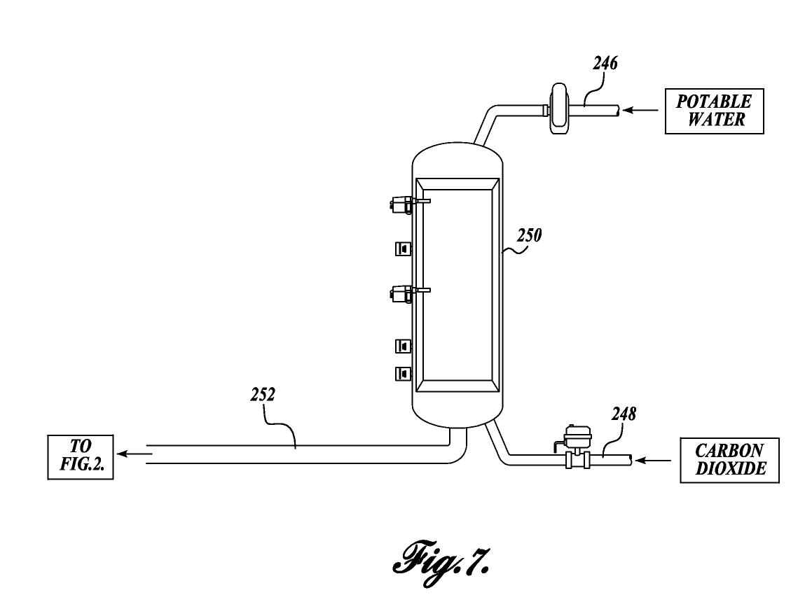

Referring to FIG. 7, a carbonic acid generator is illustrated. Carbonic acid is one representative acid that may be used in the process described above. Additionally, or alternatively, alkaline compounds may be used with an aqueous medium. Additionally or alternatively, acids, including carbonic acid, may be used. Carbonic acid is produced by combining carbon dioxide with water. Potable water is introduced via conduit 246 into vessel 250. The level of water in vessel 250 may be controlled by metering the level, and/or the amount of water that is delivered to the vessel 250. Carbon dioxide gas is supplied via conduit 248, and is likewise metered into the vessel 250. Specifically, the carbon dioxide gas may be injected via a bubble-generating device, such as a very fine mesh or material having a highly porous surface. This produces very fine carbon dioxide gas bubbles that create a large surface area of gas for dissolving into the water. The pH of the carbonic acid is less than neutral. In one embodiment, the pH is less than 4. The pH may be monitored, and more or less water may be added to the vessel 250. Additionally or alternatively, more or less carbon dioxide may be metered into the vessel 250. The carbonic acid is transferred out through conduit 252, which is then delivered to any equipment as needed, such as the combining tube 112 (FIG. 2) or the mixing tube 124 (FIG. 2).

From the description herein, a method for producing a lean beef product is disclosed. The method includes, reducing the size of beef into particles, wherein the particles are either predominantly fat particles or predominantly lean particles; combining the fat and lean particles with a fluid, wherein a density of the fluid is greater than fat particles, and a temperature of the fluid is greater than a temperature of the lean particles, and the fluid density is adjusted to provide a predetermined proportion of lean particles to sink in the fluid; allowing the fat and lean particles to rise or fall in the fluid, while the temperature of the lean particles equilibrates with the temperature of the fluid, and increases the density of the lean particles; and separating the fat particles from the lean particles to produce a lean beef product. The method may further include emulsifying the fat particles into an emulsification of oily material and solids, pasteurizing the oily material; centrifuging the emulsification to separate solids from the oily material. The method may further include combining the solids with the lean particles. The method may further include combining the lean particles with a measured amount of the fat particles, after the fat particles have been separated from the lean particles. The method may further include providing sufficient fluid to fluidize the particles, wherein the particles are free to rotate or tumble in the fluid, and exposing the fluidized particles to UVc energy to produce a pathogen deactivated beef product. The method may further include treating the lean particles under reduced pressure to adjust water content and lower the temperature of the beef product to produce a controlled water content beef product. The method may further include chilling the beef to a temperature at which the fat will break off from lean beef through application of pressure, and applying pressure to break off fat from lean and produce the particles that are either predominantly fat particles or predominantly lean particles. The method may use a fluid wherein the density is greater than 55.0 lbs/cubic foot and less than 66.0 lbs/cubic foot.

The process is not limited to being performed in any particular sequence. For example, pathogen deactivation may occur after separation, or any time before then. Some steps may be omitted and substituted for one or more steps, or that perform the similar function, or are arranged in a different sequence to perform the similar function. Some steps may be omitted that are merely ancillary, or embraced as a subsystem of the process as a whole.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for producing a lean beef product, comprising:
reducing the size of beef into particles, wherein the particles are either predominantly fat particles or predominantly lean particles;
combining the fat and lean particles with a fluid, wherein a density of the fluid is greater than fat particles, and a temperature of the fluid is greater than a temperature of the lean particles, and the fluid density is adjusted to provide a predetermined proportion of lean particles to sink in the fluid;
allowing the fat and lean particles to rise or fall in the fluid, while the temperature of the lean particles equilibrates with the temperature of the fluid, and increases the density of the lean particles; and
separating the fat particles from the lean particles to produce a lean beef product.

2. The method of claim 1, further comprising emulsifying the fat particles into an emulsification of oily material and solids, pasteurizing the oily material, and centrifuging the emulsification to separate solids from the oily material.

3. The method of claim 2, further comprising combining the solids with the lean particles.

4. The method of claim 1, further comprising combining the lean particles with a measured amount of the fat particles after the fat particles have been separated from the lean particles.

5. The method of claim 1, further comprising providing sufficient fluid to fluidize the particles, wherein the particles are free to rotate or tumble in the fluid, and exposing the fluidized particles to UVc energy to produce a pathogen deactivated beef product.

6. The method of claim 1, further comprising treating the lean particles under reduced pressure to adjust water content and lower the temperature of the beef product to produce a controlled water content beef product.

7. The method of claim 1, wherein the reducing the size of beef into particles comprises chilling the beef to a temperature at which the fat will break off from lean beef through application of pressure, and applying pressure to break off fat from lean and produce the particles that are either predominantly fat particles or predominantly lean particles.

8. The method of claim 1, wherein the fluid density is greater than 55.0 lbs/cubic foot and less than 66.0 lbs/cubic foot.
